(19) United States
(12) Patent Application Publication
(10) Pub. No.: US 2022/0203484 A1
(43) Pub. Date: Jun. 30, 2022

(54) STEEL STRUCTURE WELDING DEVICE

(71) Applicant: CHINA CONSTRUCTION SCIENCE AND INDUSTRY CORPORATION LTD., Shenzhen, Guangdong (CN)

(72) Inventors: Zhenming CHEN, Shenzhen, Guangdong (CN); Qingchuan FENG, Shenzhen, Guangdong (CN); Dongrong XIE, Shenzhen, Guangdong (CN); Zhizhen LV, Shenzhen, Guangdong (CN); Zhiyong ZUO, Shenzhen, Guangdong (CN); Shitao HUANG, Shenzhen, Guangdong (CN); Chengli XIE, Shenzhen, Guangdong (CN)

(21) Appl. No.: 17/435,814

(22) PCT Filed: Jun. 29, 2020
(86) PCT No.: PCT/CN2020/098867

§ 371 Date: Sep. 2, 2021

(30) Foreign Application Priority Data
Nov. 25, 2019 (CN) 201911164909.X

(51) Int. Cl. B23K 37/047; B23K 37/02

(52) U.S. Cl. CPC B23K 37/047; B23K 37/0229

(57) ABSTRACT

Disclosed is a steel structure welding device. The steel structure welding device includes a front positioner, a rear positioner, an auxiliary assembly trolley, and a welding robot, the front positioner includes a first base, a first driving device and a first clamping device, the first driving device is capable of driving the first clamping device to rotate relative to the first base, the first clamping device includes a first clamp and a second clamp, and the first clamp and the second clamp are capable of approaching or moving away from each other, the front positioner and the rear positioner are capable of approaching or moving away from each other, the rear positioner includes a second base and a second clamping device, the second clamping device is located on one side of the second base facing the first base.

### TECHNICAL FIELD

The present invention relates to the field of welding devices, and more particularly, to a steel structure welding device.

### BACKGROUND

Currently, final assembly welding of a steel structure is mainly implemented manually in China, and a welding quality depends on a skill level of a welder, so that it is difficult to control the welding quality. Meanwhile, fume, arc light and metal splatter may be generated during welding, and the welding is operated in a very harsh working environment. For traditional final assembly welding, a lifting worker needs to turn over components for many times to machine different parts, which leads to a low operation efficiency and increases a manual operation intensity.

### SUMMARY

The present invention aims to address at least one of the technical problems in the prior art. Therefore, the present invention provides a steel structure welding device, and a workpiece is capable of being automatically clamped and rotated through the steel structure welding device, so that the workpiece is automatically welded, thereby improving the operation efficiency and reducing the manual operation intensity.

In a first aspect, an embodiment of the present invention provides a steel structure welding device, which includes: a front positioner, the front positioner comprises a first base, a first driving device and a first clamping device, the first driving device is capable of driving the first clamping device to rotate relative to the first base, the first clamping device comprises a first clamp and a second clamp, and the first clamp and the second clamp are capable of approaching or moving away from each other;

a rear positioner, the front positioner and the rear positioner are capable of approaching or moving away from each other, the rear positioner comprises a second base and a second clamping device, the second clamping device is located on one side of the second base facing the first base, the second clamping device is rotatably arranged on the second base and a rotation axis of the second clamping device relative to the second base is collinear with that of the first clamping device relative to the first base, the second clamping device comprises a third clamp and a fourth clamp, and the third clamp and the fourth clamp are capable of approaching or moving away from each other;

an auxiliary assembly trolley, the auxiliary assembly trolley is located between the front positioner and the rear positioner, the auxiliary assembly trolley comprises a trolley body, a jacking device and a centering device, the jacking device comprises a cross beam and a second driving device, the second driving device is arranged on the trolley body, the cross beam is arranged on an output end of the second driving device, under the drive of the second driving device, the cross beam is capable of approaching or moving away from the rotation axis of the first clamping device relative to the first base, the centering device is arranged on the cross beam, the centering device comprises a third driving device, a first centering block and a second centering block, and under the drive of the third driving device, the first centering block and the second centering block are capable of approaching each other, so as to abut against a material on the cross beam; and

a welding robot, the welding robot comprises a manipulator and a welding head, the welding head is arranged on an output end of the manipulator, and under the drive of the manipulator, the welding head is capable of approaching or moving away from the rotation axis of the first clamping device relative to the first base.

The steel structure welding device provided by the embodiment of the present invention at least has the following beneficial effects: by arranging the first clamping device and the second clamping device, one end of the workpiece may be clamped by the first clamp and the second clamp, and the other end of the workpiece may be clamped by the third clamp and the fourth clamp, so that the workpiece is clamped and fixed, by arranging the first driving device, the workpiece may be rotated, which is convenient for the welding head to weld the workpiece at 360°, the front positioner and the rear positioner are capable of approaching or moving away from each other, so as to adapt to clamping of workpieces with different lengths, by arranging the auxiliary assembly trolley, the workpiece may be lifted and preliminarily clamped and positioned, which is convenient for the front positioner and the rear positioner to clamp the workpiece, and by arranging the manipulator, it is convenient to adjust a welding position of the welding head.

In the steel structure welding device according to other embodiments of the present invention, the first clamping device further includes a first hydraulic motor, a first screw rod, a first nut and a second nut, the first screw rod is fixed on an output end of the first hydraulic motor, the first nut and the second nut are both threadedly matched with the first screw rod and a threaded direction of the first nut is opposite to that of the second nut, the first clamp is fixed on the first nut, and the second clamp is fixed on the second nut.

In the steel structure welding device according to other embodiments of the present invention, the front positioner further comprises a hydraulic rotary joint, the hydraulic rotary joint comprises a rotating shaft and a housing, the housing is fixed on the first base, and an oil inlet/outlet port of the rotating shaft is connected with the hydraulic motor.

In the steel structure welding device according to other embodiments of the present invention, the front positioner further includes a third clamping device, the third clamping device comprises a third hydraulic motor, a third screw rod, a fifth nut, a sixth nut, a fifth clamp and a sixth clamp, the third hydraulic motor is fixed relative to the first hydraulic motor, the third screw rod is fixed on an output end of the third hydraulic motor, the fifth nut and the sixth nut are both threadedly matched with the third screw rod and a threaded direction of the fifth nut is opposite to that of the sixth nut, the fifth clamp is fixed on the fifth nut, the sixth clamp is fixed on the sixth nut, and an included angle excluding 0 degree exists between the third screw rod and the first screw rod.

In the steel structure welding device according to other embodiments of the present invention, the first driving device includes a first slewing bearing and a first swivel plate, the first slewing bearing comprises a first inner ring and a first outer ring, the first inner ring is fixed on the first base, the first swivel plate is fixed on the first outer ring, and the first clamping device is arranged on the first swivel plate.

In the steel structure welding device according to other embodiments of the present invention, the first driving device includes a first motor and a first gear, the first gear is fixed on a rotating shaft of the first motor, teeth are arranged on an outer circumferential surface of the first outer ring, and the first gear is meshed with the first outer ring.

In the steel structure welding device according to other embodiments of the present invention, the front positioner further includes a first welding grounding device, the first welding grounding device comprises a first conductive block and a first elastic element, one end of the first conductive block is capable of being electrically connected with the outside, and the other end of the first conductive block is capable of abutting against one side of the first swivel plate far away from the first inner ring under an action of the first elastic element.

In the steel structure welding device according to other embodiments of the present invention, the first elastic element is a compression spring, one end of the compression spring abuts against the first base, and the other end of the compression spring abuts against the conductive block.

In the steel structure welding device according to other embodiments of the present invention, the centering device further includes a fifth screw rod, a ninth nut and a tenth nut, the third driving device is a fifth hydraulic motor, the fifth hydraulic motor is fixed on the cross beam, the fifth screw rod is fixed on an output end of the fifth hydraulic motor, the ninth nut and the tenth nut are both threadedly connected with the fifth screw rod and a threaded direction of the ninth nut is opposite to that of the tenth nut, the first centering block is fixed on the ninth nut, and the second centering block is fixed on the tenth nut.

In the steel structure welding device according to other embodiments of the present invention, the second driving device is a hydraulic oil cylinder.

### BRIEF DESCRIPTION OF THE DRAWINGS

FIG. 1 is a front view of a steel structure welding device of a first embodiment;

FIG. 2 is a top view of FIG. 1;

FIG. 3 is a left view of FIG. 1;

FIG. 4 is a front view of a front positioner in FIG. 1;

FIG. 5 is a right view of FIG. 4;

FIG. 6 is an enlarged view of an I region in FIG. 5;

FIG. 7 is a front view of a rear positioner in FIG. 1;

FIG. 8 is a right view of FIG. 7;

FIG. 9 is a front view of an auxiliary assembly trolley in FIG. 1;

FIG. 10 is a top view of FIG. 9; and

FIG. 11 is a left view of FIG. 9.

### DETAILED DESCRIPTION

The concept and the generated technical effect of the present invention are clearly and completely described hereinafter with reference to the embodiments to fully understand the objectives, the features and the effects of the present invention. Obviously, the described embodiments are only some but not all of the embodiments of the present invention, and based on the embodiments of the present invention, other embodiments obtained by those skilled in the art without going through any creative work all belong to the scope of protection of the present invention.

In the description of the embodiments of the present invention, the orientation or position relationship indicated by the terms “up”, “down”, “front”, “rear”, “left”, “right”, and the like is based on the orientation or position relationship shown in the accompanying drawings, it is only for the convenience of description of the present invention and simplification of the description, and it is not to indicate or imply that the indicated device or element must have a specific orientation, and be constructed and operated in a specific orientation. Therefore, the terms shall not be understood as limiting the present invention.

In the description of the embodiments of the present invention, if some feature is “arranged”, “fixed”, “connected” or “installed” on another feature, the feature may be directly arranged, fixed or connected to another feature, or indirectly set, fixed, connected or installed on another feature. In the description of the embodiments of the present invention, the meaning of “several” refers to be one or more, and the meaning of “multiple” refers to be more than two. The meanings of “greater than”, “less than”, “more than”, and the like should be understood as not including this number, while the meanings of “above”, “below”, “within”, and the like should be understood as including this number. The terms “first” and “second” should be understood as being used for distinguishing the technical features only in the description, and cannot be understood as indicating or implying relative importance, implicitly indicating the number of technical features indicated thereby, or implicitly indicating the order of technical features indicated thereby.

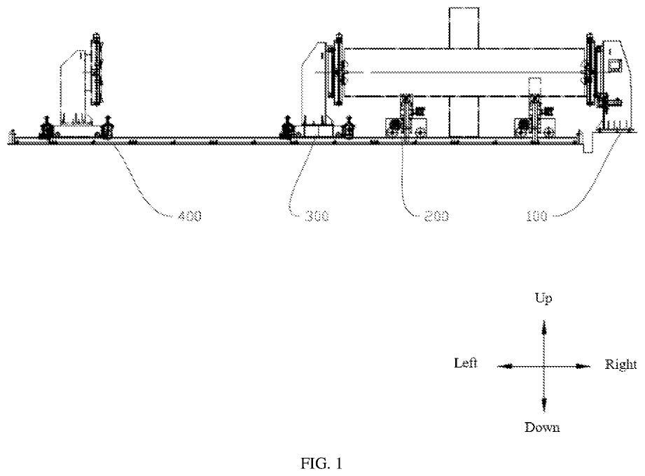

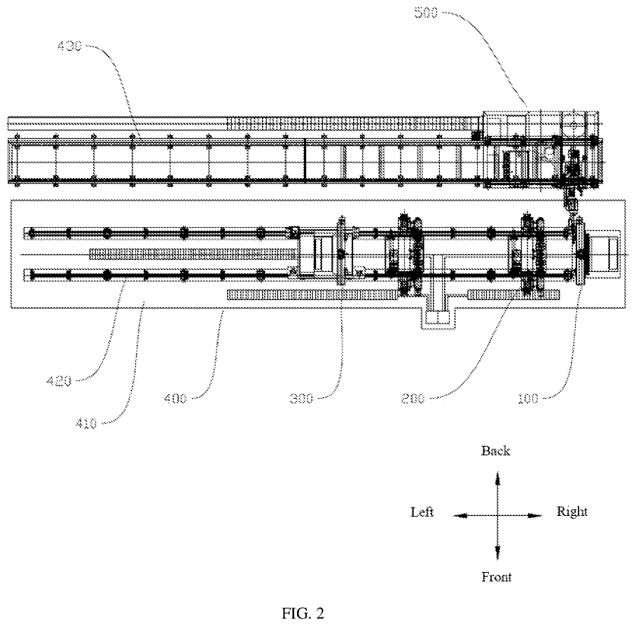

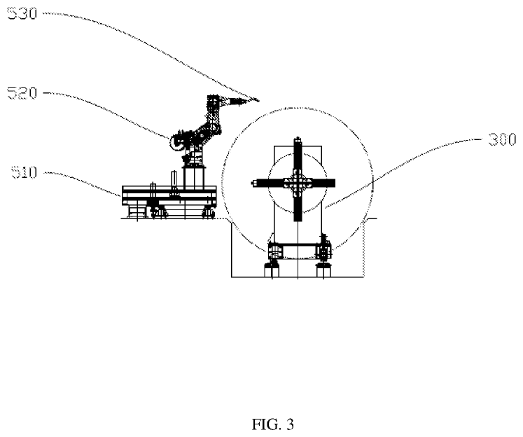

Referring to FIG. 1 to FIG. 3, FIG. 1 is a front view of a steel structure welding device of a first embodiment, FIG. 2 is a top view of FIG. 1, and FIG. 3 is a left view of FIG. 1. The steel structure welding device of the embodiment includes a front positioner 100, an auxiliary assembly trolley 200, a rear positioner 300, a frame 400 and a welding robot 500. The frame 400 includes a base 410, a first guide rail 420 and a second guide rail 430. The front positioner 100, the first guide rail 420 and the second guide rail 430 are all fixed on the base 410, and the front positioner 100 is located at a right end of the first guide rail 420. The auxiliary assembly trolley 200 and the rear positioner 300 are arranged on the first guide rail 420, and the auxiliary assembly trolley 200 is located between the front positioner 100 and the rear positioner 300. The rear positioner 300 may slide left and right along the first guide rail 420, so as to match with the front positioner 100 to clamp and fix workpieces with different lengths, and the auxiliary assembly trolley 200 may slide left and right along the first guide rail 420, so as to support the workpiece at a proper position to complete preliminary clamping and positioning.

The second guide rail 430 and the first guide rail 420 are arranged in parallel, and the welding robot 500 is arranged on the second guide rail 430. The welding robot 500 includes a welding trolley 510, a manipulator 520 and a welding head 530. The manipulator 520 is arranged on the welding trolley 510, and the welding head 530 is fixed on an output end of the manipulator 520. In the embodiment, the welding trolley 510 may move left and right along the second guide rail 430 through a rack and pinion mechanism, so as to complete welding of different structures of the workpiece in left and right directions, and the manipulator 520 is also arranged on the welding trolley 510 through a rack and pinion mechanism, so that the manipulator 520 may move forward and backward relative to the welding trolley 510 (with reference to FIG. 2), and the manipulator 520 may operate the welding head 530 more flexibly.

In the embodiment, the manipulator 520 is a six-axis manipulator. In other embodiments, the manipulator 520 may also be specifically set as required, such as a three-axis manipulator.

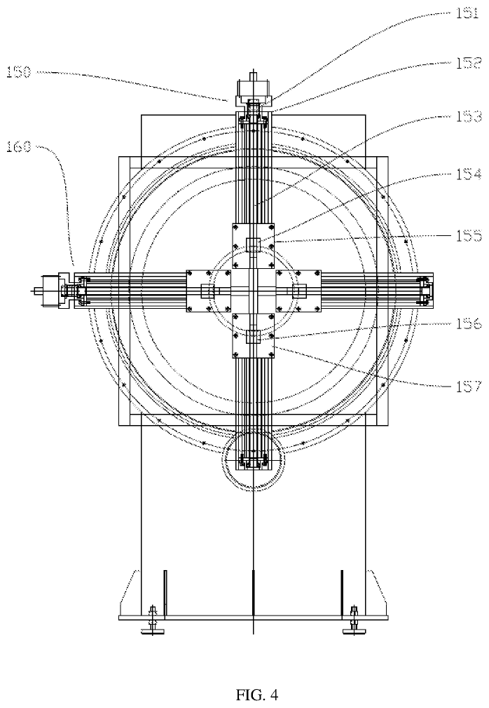

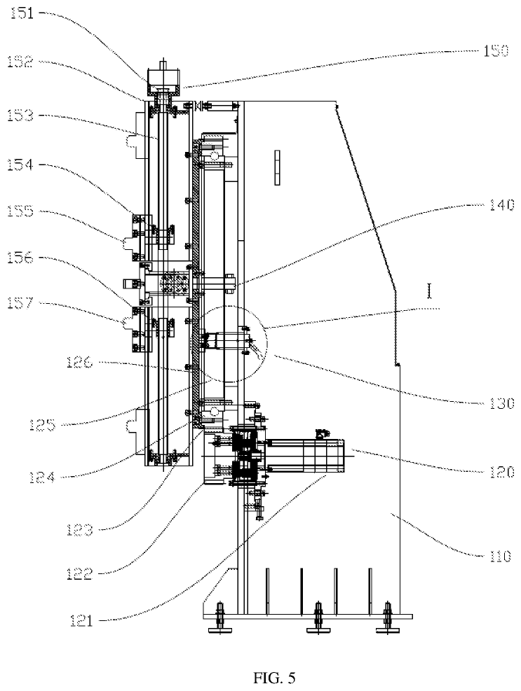

Referring to FIG. 4 and FIG. 5, FIG. 4 is a front view of the front positioner 100 in FIG. 1, and FIG. 5 is a right view of FIG. 4. The front positioner 100 includes a first base 110, a first driving device 120, a first welding grounding device 130, a hydraulic rotary joint 140, a first clamping device 150 and a third clamping device 160. The first base 110 is fixed on the base 410 by fastening a bolt with a nut. The first driving device 120 includes a first motor 121, a first gear 122, a first slewing bearing 123 and a first swivel plate 126. The first motor 121 is fixed on the first base 110, and the first gear 122 is fixed on a rotating shaft of the first motor 121. The first slewing bearing 123 includes a first outer ring 124 and a first inner ring 125. The first inner ring 125 is fixed on the first base 110 by fastening a screw, and the first swivel plate 126 is fixed on the first outer ring 124 by fastening a screw, thus rotatably connecting the first swivel plate 126 with the first base 110. In order to drive the first swivel plate 126 to rotate relative to the first base 110, teeth are uniformly arranged on an outer circumferential surface of the first outer ring 124, and the first gear 122 is meshed with the first outer ring 124, so that the first swivel plate 126 is capable of rotating relative to the first base 110 under the drive of the first motor 121.

The first clamping device 150 and the third clamping device 160 are both fixed on one side of the first swivel plate 126 far away from the first slewing bearing 123, and a structure of the first clamping device 150 is completely the same as that of the third clamping device 160, but there is a difference in positions of the first clamping device and the third clamping device on the first swivel plate 126. Specifically, the first clamping device 150 includes a first hydraulic motor 151, a first mounting base 152, a first screw rod 153, a first nut 154, a first clamp 155, a second nut 156 and a second clamp 157. The first mounting base 152 is fixed on the first swivel plate 126 by fastening a screw, the first hydraulic motor 151 is fixed on the first mounting base 152, the first screw rod 153 is fixed on a rotating shaft of the first hydraulic motor 151, the first nut 154 and the second nut 156 are both threadedly matched with the first screw rod 153, and a threaded direction of the first nut 154 is opposite to that of the second nut 156. The first clamp 155 is fixed on the first nut 154, and the second clamp 157 is fixed on the second nut 156.

Therefore, under the drive of the first hydraulic motor 151, the first clamp 155 and the second clamp 157 are capable of being close to each other to clamp one end of the workpiece, and the first clamp 155 and the second clamp 157 are also capable of being far away from each other to release the workpiece.

The third clamping device 160 includes a third hydraulic motor, a third mounting base, a third screw rod, a fifth nut, a fifth clamp, a sixth nut and a sixth clamp. A structure of the third clamping device 160 is completely the same as that of the first clamping device 150, which will not be repeated herein. In addition, the third screw rod and the first screw rod 153 are vertically arranged, and under an action of a height difference between the third mounting base and the first mounting base 152, the third screw rod and the first screw rod 153 are staggered to prevent interference. Under the drive of the third hydraulic motor, the fifth clamp and the sixth clamp are capable of being close to each other, so as to match with the first clamp 155 and the second clamp 157 to clamp one end of the workpiece.

In another embodiment, an included angle between the third screw rod and the first screw rod may also be other degrees excluding 0 degree. Therefore, the fifth clamp and the sixth clamp may also be matched with the first clamp 155 and the second clamp 157 to clamp one end of the workpiece.

In another embodiment, the third clamping device 160 may not be provided, and the first clamping device 150 may independently clamp one end of the workpiece.

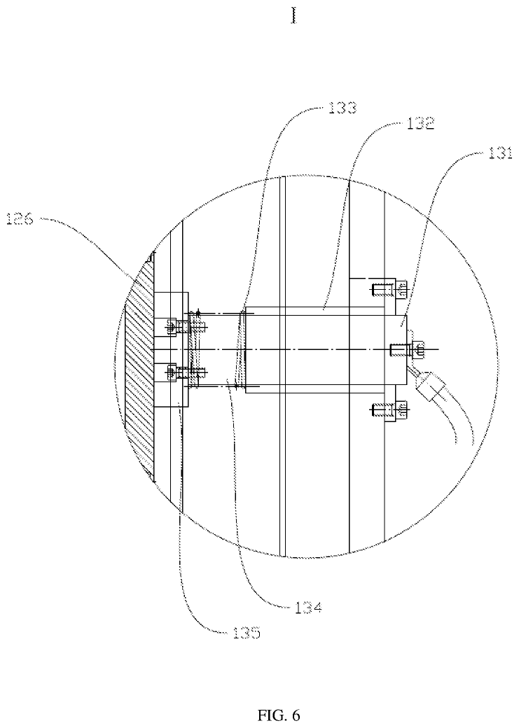

Referring to FIG. 5 and FIG. 6, FIG. 6 is an enlarged view of an I region in FIG. 5. In the embodiment, when the workpiece is welded, the workpiece is capable of being communicated with a welding circuit to form a loop. The first welding grounding device 130 is provided, and the first welding grounding device 130 includes a first conductive block 131, a first limiting member 132 and a first elastic element 133. One end of the first conductive block 131 is capable of being electrically connected with an external wire through a screw and a washer. Under an action of the first elastic element 133, the other end of the first conductive block 131 tightly abuts against the first swivel plate 126 to electrically connect the first conductive block 131 with the first swivel plate 126. Therefore, during rotation of the first swivel plate 126, a welding current may also form a loop through the workpiece, the first clamp 155 (or the second clamp 157), the first swivel plate 126 and the first conductive block 131 for stable welding.

In the embodiment, the first conductive block 131 includes a shaft 134 and a shaft shoulder 135. The first elastic element 133 is a compression spring, and the first limiting member 132 is fixed on the first base 110 by fastening. A limiting hole is arranged in the first limiting member 132, and the shaft 134 is in clearance fit with the limiting hole. After the compression spring is sleeved on the shaft 134, the shaft 134 is inserted into the limiting hole. Therefore, one end of the compression spring abuts against the first limiting member 132, and the other end of the compression spring abuts against the shaft shoulder 135. Under an action of the compression spring, the shaft shoulder 135 always abuts against the first swivel plate 126 to ensure normal welding.

In the embodiment, the first conductive block 131 is made of copper. In another embodiment, a rubber sleeve or a corrugated tube may also be used as the first elastic element 133.

In the embodiment, in order to provide a hydraulic pressure to the first hydraulic motor 151 and the third hydraulic motor, and prevent a hose that provides the hydraulic pressure from twisting when the first swivel plate 126 rotates at the same time, which will make the first clamping device 150 and the third clamping device 160 fail to operate normally, the hydraulic rotary joint 140 is provided. The hydraulic rotary joint 140 includes a housing and a rotating shaft, the housing is fixed on the first base 110, and an oil inlet/outlet port of the rotating shaft is connected with the first hydraulic motor 151 and the third hydraulic motor.

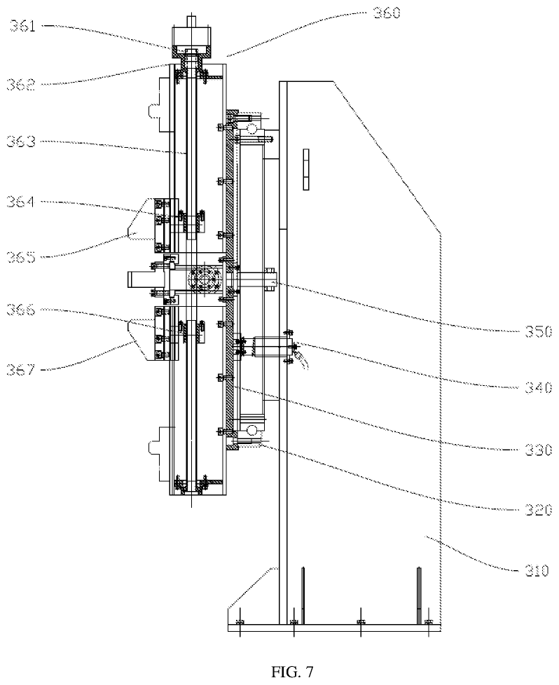

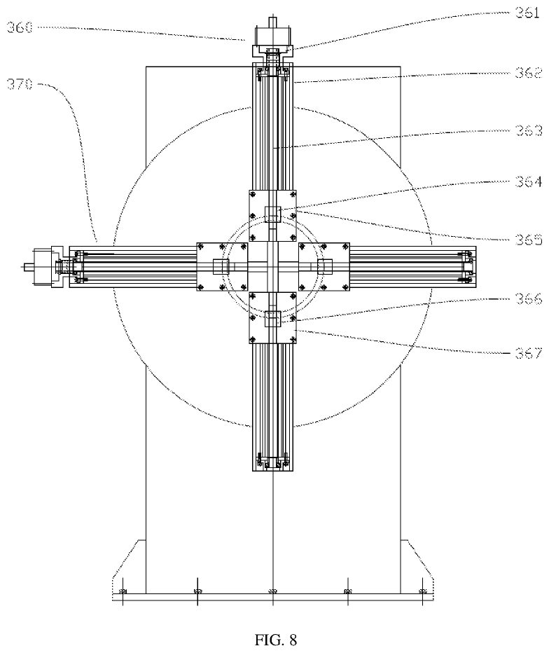

Referring to FIG. 7 and FIG. 8, FIG. 7 is a front view of the rear positioner in FIG. 1, and FIG. 8 is a right view of FIG. 7. A structure of the rear positioner 300 is similar to that of the front positioner 100, except that the rear positioner 300 is provided with the first driving device 120. Specifically, the rear positioner 300 includes a second base 310, a second slewing bearing 320, a second swivel plate 330, a second welding grounding device 340, a second hydraulic rotary joint 350, a second clamping device 360 and a fourth clamping device 370. The second swivel plate 330 is rotatably arranged on the second base 310 through the second slewing bearing 320, and the second clamping device 360 and the fourth clamping device 370 are both arranged on one side of the second swivel plate 330 far away from the second base 310. The second clamping device 360 includes a second hydraulic motor 361, a second mounting base 362, a second screw rod 363, a third nut 364, a third clamp 365, a fourth nut 366 and a fourth clamp 367. A structure of the second clamping device 360 is completely the same as that of the first clamping device 150. Under the drive of the second hydraulic motor 361, the third clamp 365 and the fourth clamp 367 are capable of approaching or moving away from each other, so as to clamp or release the other end of the workpiece.

A positional relationship between the fourth clamping device 370 and the second clamping device 360 is the same as that between the first clamping device 150 and the third clamping device 160. In addition, a structure of the second welding grounding device 340 is the same as that of the first welding grounding device 130, and the second hydraulic rotary joint 350 is arranged in the same way as the first hydraulic rotary joint 140.

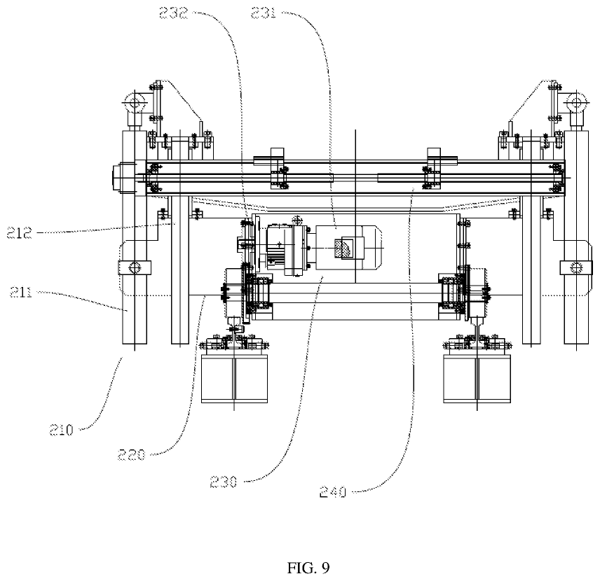

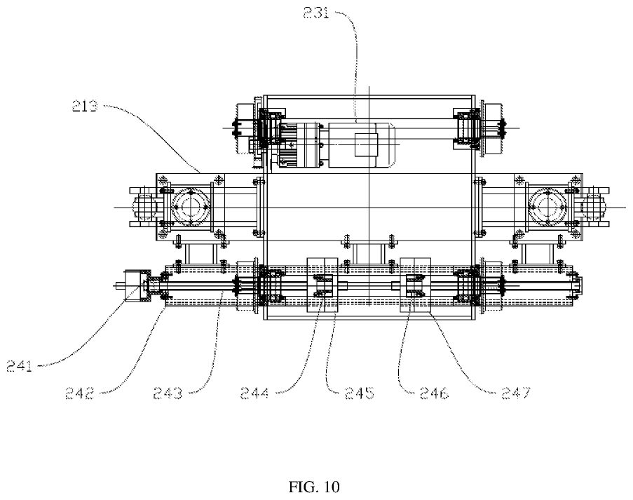

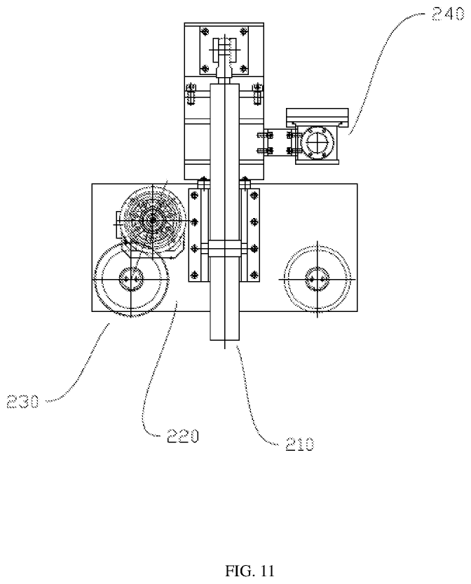

Referring to FIG. 1, FIG. 9, FIG. 10 and FIG. 11, FIG. 9 is a front view of the auxiliary assembly trolley 200 in FIG. 1, FIG. 10 is a top view of FIG. 9, and FIG. 11 is a left view of FIG. 9. The auxiliary assembly trolley 200 includes a jacking device 210, a trolley body 220, a traveling driving device 230 and a centering device 240. The jacking device 210 includes a second driving device 211, a guide rod 212 and a cross beam 213. The second driving device 211 is matched with the guide rod 212 for use, and two sets of second driving devices 211 and guide rods 212 are arranged on two sides of the trolley body 220. The guide rods 212 are slidably connected with the trolley body 220, and both ends of the cross beam 213 are respectively fixed on the two guide rods 212. Under the drive of the second driving device 211, the cross beam 213 is capable of approaching or moving away from the trolley body 220. In the embodiment, the second driving device 211 is a hydraulic oil cylinder.

Therefore, after the workpiece is hoisted in place, the workpiece is placed on the cross beam 213 first and lifted to a proper position by the jacking device 210, which is convenient for the front positioner 100 and the rear positioner 300 to clamp the workpiece.

The centering device 240 is arranged on one side of the cross beam 213, and the centering device 240 includes a fifth hydraulic motor 241, a fifth mounting base 242, a fifth screw rod 243, a ninth nut 244, a first centering block 245, a tenth nut 246 and a second centering block 247. The fifth mounting base 242 is fixed on the cross beam 213 by fastening, the fifth hydraulic motor 241 is fixed on one end the fifth mounting base 242, the fifth screw rod 243 is fixed on a rotating shaft of the fifth hydraulic motor 241, the ninth nut 244 and the tenth nut 246 are both threadedly matched with the fifth screw rod 243, and a threaded direction of the ninth nut 244 is opposite to that of the tenth nut 246. The first centering block 245 is fixed on the ninth nut 244, and the second centering block 247 is fixed on the tenth nut 246. Under the drive of the fifth hydraulic motor 241, the first centering block 245 and the second centering block 247 are close to each other at a same speed. Therefore, when workpieces with different diameters are placed on the cross beam 213, under actions of the first centering block 245 and the second centering block 247, the workpieces may all move to a middle position of the cross beam 213 to implement positioning, which is convenient for the front positioner 100 and the rear positioner 300 to clamp the workpieces.

In order to move the cross beam 213 to a proper position between the front positioner 100 and the rear positioner 300, and support the workpiece well, the traveling driving device 230 is provided. The traveling driving device 230 includes a second motor 231 and a second gear 232. Rotation of the second motor 231 is transmitted to the second gear 232 after being decelerated by a speed reducer. The trolley body 220 is rotatably provided with a roller, and the second gear 232 is meshed with teeth of the roller, so as to drive the auxiliary assembly trolley 200 to move on the first guide rail 420.

Similarly, a movement of the rear positioner 300 on the first guide rail 420 may also be implemented by setting the same device as the traveling driving device 230.

The embodiments of the present invention are described in detail with reference to the accompanying drawings above, but the present invention is not limited to the above embodiments, and various changes may also be made within the knowledge scope of those of ordinary skills in the art without departing from the purpose of the present invention. In addition, the embodiments of the present invention and the features in the embodiments may be combined with each other without conflict.

What is claimed is:

1. A steel structure welding device, comprising:
a front positioner, wherein the front positioner comprises a first base, a first driving device and a first clamping device, the first driving device is capable of driving the first clamping device to rotate relative to the first base, the first clamping device comprises a first clamp and a second clamp, and the first clamp and the second clamp are capable of approaching or moving away from each other;
a rear positioner, wherein the front positioner and the rear positioner are capable of approaching or moving away from each other, the rear positioner comprises a second base and a second clamping device, the second clamping device is located on one side of the second base facing the first base, the second clamping device is rotatably arranged on the second base and a rotation axis of the second clamping device relative to the second base is collinear with that of the first clamping device relative to the first base, the second clamping device comprises a third clamp and a fourth clamp, and the third clamp and the fourth clamp are capable of approaching or moving away from each other;
an auxiliary assembly trolley, wherein the auxiliary assembly trolley is located between the front positioner and the rear positioner, the auxiliary assembly trolley comprises a trolley body, a jacking device and a centering device, the jacking device comprises a cross beam and a second driving device, the second driving device is arranged on the trolley body, the cross beam is arranged on an output end of the second driving device, under the drive of the second driving device, the cross beam is capable of approaching or moving away from the rotation axis of the first clamping device relative to the first base, the centering device is arranged on the cross beam, the centering device comprises a third driving device, a first centering block and a second centering block, and under the drive of the third driving device, the first centering block and the second centering block are capable of approaching each other, so as to abut against a material on the cross beam; and
a welding robot, wherein the welding robot comprises a manipulator and a welding head, the welding head is arranged on an output end of the manipulator, and under the drive of the manipulator, the welding head is capable of approaching or moving away from the rotation axis of the first clamping device relative to the first base.

2. The steel structure welding device of claim 1, wherein the first clamping device further comprises a first hydraulic motor, a first screw rod, a first nut and a second nut, the first screw rod is fixed on an output end of the first hydraulic motor, the first nut and the second nut are both threadedly matched with the first screw rod and a threaded direction of the first nut is opposite to that of the second nut, the first clamp is fixed on the first nut, and the second clamp is fixed on the second nut.

3. The steel structure welding device of claim 2, wherein the front positioner further comprises a hydraulic rotary joint, and the hydraulic rotary joint comprises a rotating shaft and a housing, the housing is fixed on the first base, and an oil inlet/outlet port of the rotating shaft is connected with the first hydraulic motor.

4. The steel structure welding device of claim 2, wherein the front positioner further comprises a third clamping device, the third clamping device comprises a third hydraulic motor, a third screw rod, a fifth nut, a sixth nut, a fifth clamp and a sixth clamp, the third hydraulic motor is fixed relative to the first hydraulic motor, the third screw rod is fixed on an output end of the third hydraulic motor, the fifth nut and the sixth nut are both threadedly matched with the third screw rod and a threaded direction of the fifth nut is opposite to that of the sixth nut, the fifth clamp is fixed on the fifth nut, the sixth clamp is fixed on the sixth nut, and an included angle excluding 0 degree exists between the third screw rod and the first screw rod.

5. The steel structure welding device of claim 1, wherein the first driving device comprises a first slewing bearing and a first swivel plate, the first slewing bearing comprises a first inner ring and a first outer ring, the first inner ring is fixed on the first base, the first swivel plate is fixed on the first outer ring, and the first clamping device is arranged on the first swivel plate.

6. The steel structure welding device of claim 5, wherein the first driving device further comprises a first motor and a first gear, the first gear is fixed on a rotating shaft of the first motor, teeth are arranged on an outer circumferential surface of the first outer ring, and the first gear is meshed with the first outer ring.

7. The steel structure welding device of claim 5, wherein the front positioner further comprises a first welding grounding device, the first welding grounding device comprises a first conductive block and a first elastic element, one end of the first conductive block is capable of being electrically connected with the outside, and the other end of the first conductive block is capable of abutting against one side of the first swivel plate far away from the first inner ring under an action of the first elastic element.

8. The steel structure welding device of claim 7, wherein the first elastic element is a compression spring, one end of the compression spring is configured to abut against the first base, and the other end of the compression spring is configured to abut against the conductive block.

9. The steel structure welding device of claim 1, wherein the centering device further comprises a fifth screw rod, a ninth nut and a tenth nut, the third driving device is a fifth hydraulic motor, the fifth hydraulic motor is fixed on the cross beam, the fifth screw rod is fixed on an output end of the fifth hydraulic motor, the ninth nut and the tenth nut are both threadedly connected with the fifth screw rod and a threaded direction of the ninth nut is opposite to that of the tenth nut, the first centering block is fixed on the ninth nut, and the second centering block is fixed on the tenth nut.

10. The steel structure welding device of claim 1, wherein the second driving device is a hydraulic oil cylinder.
